(19) United States
(12) Patent Application Publication
(10) Pub. No.: US 2006/0059729 A1
(43) Pub. Date: Mar. 23, 2006

(54) Tree extraction method and apparatus

(76) Inventor: Robert Hageman, Austin, TX (US)

Correspondence Address: DAVID G. HENRY, 900 Washington Avenue, 7th Floor, P.O. Box 1470, Waco, TX, 77603-1470, US

(21) Appl. No.: 10/947,073

(22) Filed: Sep. 22, 2004

(51) Int. Cl. A01G 23/06

(52) U.S. Cl. 37/302

(57) ABSTRACT

A tree extraction system with a frame for mounting to a host vehicle with hydraulic system and including articulated jaws, supported by the frame and designed to grasp a tree trunk, and reversibly extending leg members for forcing the frame and attached jaw assembly upward relative to a ground surface to extract any tree engaged with the jaws.

### FIELD OF THE INVENTION

Applicant's invention generally relates to an improved method and apparatus for tree removal. More specifically, Applicant's invention relates to an improved tree removal method and apparatus whereby lateral force, or torque about the removing apparatus, is virtually eliminated during the removal process. As such, the method is extremely efficient as less energy is used and damage to the surrounding ground surface is greatly reduced. The present invention provides for a pace of tree or shrub extraction not available with any known systems.

### BACKGROUND INFORMATION

The necessity and practice of removing trees and shrubs from various parcels of land has been around since man first decided to settle in a single place. Nevertheless, “clearing” land is one of the most difficult tasks involved in any sort of real estate development. Specifically, removing an entire tree (roots included) requires an amount of brute strength beyond the capacity of most humans. Further, cutting a tree from the stump up requires the use of cumbersome machinery and doesn't entirely solve the problem. In light of the extraordinary difficulty in getting rid of unwanted vegetation, heavy machinery is often relied upon to achieve this arduous task.

However, even the largest of industrial equipment cannot remove vegetation in the most satisfactory way. For example, known systems in the art rely on knocking a tree over, or dragging a tree out of the ground. However, these systems require a relatively large working areas, are not efficient, and necessarily damage the surroundings. The logging industry heavily relies upon a machine that consists of a single-use rubber tire machine that engages a tree near the ground surface with grippers and then saws the tree at stump level, from there the tree is transported to a logging truck. In view or the present invention, however, the aforementioned system is unsatisfactory. Applicant's invention provides a method and apparatus whereby a tree may be completely removed (i.e., even the roots).

Even currently available systems that claim to remove trees and their roots are of little practical application. The most common of such systems is the “blade” that often is attached to a tractor. However, this system is plagued with problems that are eliminated by the current invention. Specifically, the blade system requires that a tractor drive over the tree itself, which often leads to damage to the tractor components (i.e., rubber tires) and the surrounding surface vegetation. Further, the blade dives down into the dirt, thereby plowing below ground to reach the roots. As such, to have any practical effect at all, the ground must be soft, and be free or rocks or underground wiring/plumbing. Finally, this system provides for no efficient manner to transport the knocked-over tree.

Commonly used equipment lacks the agility to remove trees from confined or fragile areas, such as along fence lines, along riverbeds, or between in-place structures (such as light posts, electrical boxes, etc.). The present invention, however, extracts trees in a completely vertical manner, thereby greatly reducing needed “working space.” In fact, one of the most beneficial applications of the present invention is in the context of fence building, where the fence line must be cleaned of shrubbery before post-setting or wire-stringing may occur.

In view of the limitations of currently available tree removal systems, a great need exists for a method and apparatus for removing trees in an efficient manner. The present system satisfies such a need in several ways. Applicant's invention mounts to most any common hydraulic system of tractors. The present invention takes up only minimal ground space, and is extremely nimble in its operation. Further, an operator may engage a tree or shrub in very close proximity. This feature greatly reduces the extraction work site, and increases the mechanical efficiency of the process. Specifically, the tree undergoes only a vertical motion as it is lifted from the ground. The present invention is thought to be particularly useful for selective removal of scrub brush/trees and their roots so that real estate may be prospectively observed while little damage would be done to either above-ground and below-ground structure.

### SUMMARY OF THE INVENTION

In view of the foregoing, it is an object of the present invention to provide an improved method and apparatus for extracting growing (or dead) trees and the like.

It is another object of the present invention to provide an improved method and apparatus for extracting growing (or dead) trees and the like, which apparatus is designed for simultaneous removal of above and below-ground portions of a to-be-removed tree or stump.

It is another object of the present invention to provide an improved method and apparatus for extracting growing (or dead) trees and the like, which apparatus, in addition to, or instead of the preceding features, enables direct, visual observation by the user for tree apparatus positioning and tree or stump engagement.

It is another object of the present invention to provide an improved method and apparatus for extracting growing (or dead) trees and the like, which apparatus, in addition to, or instead of the preceding features, is designed as an accessory to existing host vehicles (such as farm/landscaping tractors), thereby eliminating otherwise substantial portions of costs of acquisition.

It is another object of the present invention to provide an improved method and apparatus for extracting growing (or dead) trees and the like, which apparatus, in addition to, or instead of the preceding features, obviates equipment hazards associated with subterranean obstacles, hard soil, and the like.

In satisfaction of these and other related objectives, Applicant's present invention provides a tree extraction system which is based on an apparatus designed for attachment to a conventional farm/landscaping tractor with hydraulic system. Alternative host vehicles can be used, provided suitable interface hardware and hydraulic systems are provided. The apparatus of the present invention, in its preferred embodiment, mounts to the standard accessory platform of a farm tractor, and its hydraulic fittings are likewise designed for interface with such tractors systems, as would otherwise be used for hydraulicly-actuated farm or construction implements.

The two primary sub-systems of any embodiment of the present invention are; (1) articulated jaws which are designed to securely grasp a tree trunk and which are attached to an apparatus framework; and (2) leg members which include reversibly extendable hydraulic pistons with foot pads attached at distal ends and which, upon extension, force the apparatus framework upward (away from the ground surface) bringing any jaws-engaged tree or stump with it.

The referenced jaws are positioned for grasping a tree or tree truck well above ground level. Therefore, maneuvering the jaws into position for tree extraction is a simple process. Avoided are any complications associated with subterranean obstacles, as well as any need for cutting a tree first, and only then removing the stump.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a perspective view of the tree extraction system of the present invention.

### DETAILED DESCRIPTION OF THE PREFERRED EMBODIMENT

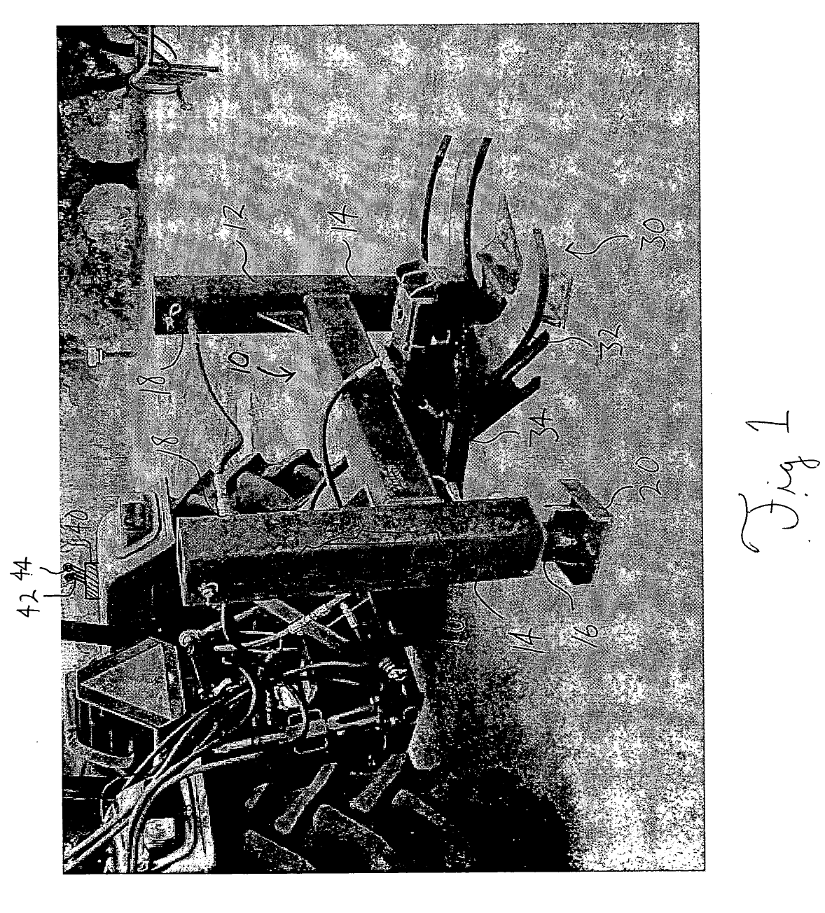

With reference to FIG. 1, the tree extraction system of the present invention is identified generally by the reference number 10.

Extraction system 10 includes, in its most basic embodiment, a frame 12. Frame 12 includes suitable fittings for mechanical engagement with the accessories mounting system of anticipated host vehicles (conventional farm tractors, for example). Frame 12, when so mounted, will be moveable between a first, rest position wherein the frame is at its closest proximity to the ground surface over which system 10 is position, and a second, extraction position wherein frame 12 is raised to a greater distance from the ground surface. This allowed movement may be a feature of the structure of frame 12, a feature of the mounting system of the host vehicle itself, or a combination of the two.

In the preferred embodiment, frame 12 includes, at either end, leg members 14. Positioned within, or otherwise associated with each leg member 14 is a hydraulic cylinder assembly 16. At the distal end of the piston 18 of each hydraulic cylinder assembly 16 is a foot pad, or ground-engaging plate 20.

Hydraulic cylinder assembly 16 receives hydraulic fluid deliver for extension and retraction from conventional hydraulic system components, such as are found on farm tractors, to which embodiments of the present invention are envisioned to be attached in most cases. Accordingly, conventional hydraulic couplings are used in system 10, and need not here be more extensively described.

Mounted to frame 12 is a jaw assembly 30. Jaw assembly 30 includes two articulated jaws 32 (less-preferred, alternative embodiments may involve only one moving jaw, which moves relative to a stationary second jaw). In the preferred embodiment, jaws 32 move under action of one or more hydraulic cylinders 34 (one can fashion system 10 to include two cylinders—one cylinder for each jaw—working in concert to move the jaws 32, or to include one cylinder with appropriate mechanical linkages for operating both jaws 32 under action of the one cylinder. In any event, jaws 32 move from a first, “open” position (shown in the drawings) for receiving the trunk of a to-be-removed tree there between, and a second, “grabbing” position in which the jaws are more closely juxtaposed for securely engaging a tree truck. Note that this second position may involve a range of positions for jaws 32, as trees of differing diameters are grasped by jaws 32.

Hydraulic cylinder(s) 34 receive hydraulic fluid delivery for articulation of jaws 32 from conventional hydraulic system components, such as are found on farm tractors, to which embodiments of the present invention are envisioned to be attached in most cases.

Controls 40 are suitably mounted on a host vehicle (not shown in the drawings) for actuating hydraulic cylinder(s) 34 and hydraulic cylinder assemblies 16. Control lever or switch 42 is, in the preferred embodiment, integrated into the hydraulic control system such that, when switch 42 is pressed one side of neutral, it moves jaws 32 from their first, open position toward their second, grabbing position, but when moved toward the opposite side of neutral, move jaws 32 in the opposite direction. Likewise, control lever or switch 44 is, in the preferred embodiment, integrated into the hydraulic control system such that, when switch 44 is pressed one side of neutral, it extends both hydraulic pistons 18, but when moved toward the opposite side of neutral, retract pistons 18.

As previously mentioned, use of the present invention is believed to be best carried out in association with a conventional farm/landscaping tractor (or such other vehicle as at least includes a suitable mounting hardware and hydraulic system). When mounted on the accessory support assembly of a conventional tractor (not shown in the drawings), one extracts a tree by maneuvering the host vehicle such that jaws 32 are astride the tree trunk (frame 12 will be in its “rest position”). Switch 42 is actuated such that jaws 32 move toward a grabbing position to firmly grasp the tree trunk (usually to a point of biting into the bark for sure engagement). Then, switch 44 is actuated to extend pistons 18 of hydraulic cylinder assemblies 16. Under force of the extending pistons 18, frame 12 (to which jaws 32 are attached, at least indirectly) rises toward its “extraction position” and the tree, with which jaws 32 are securely engaged, is literally pulled from the ground.

After the tree is extracted, jaws 32 are opened, and the extracted tree is allowed to drop, or the tree may be transported to a disposal location before release. It should be noted that the relative arrangement of jaws 32 and leg members 14, with its hydraulic cylinder assemblies 16 are particularly significant in achieving the efficacy of the present system. Because the force which extracts the tree or stump is applied, via the foot plates 20 very nearly astride the to-be-removed tree itself (rather than, for example, from a more remote position, such as from the tractor itself), there is minimal lateral mechanical reaction such that the tree need nearly be dragged laterally through rock and soil, or such that substantial torque is applied to the apparatus itself. Rather, by placing an effective fulcrum substantially adjacent the point of extraction, the tree is simply plucked vertically from the ground with a resulting minimization of required force to achieve the extraction. As a nice side benefit: when a tree removed in this manner, as compared to alternative means of tree removal, damage to surrounding ground surfaces are minimized. These benefits would not be provided if, for example, frame 12 was itself raised by a remote force, rather than, as in this case, frame 12 “raising itself.”

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A tree extraction apparatus comprising:
a frame having mechanical interface means for mounting on a host vehicle, said mechanical interface means being configured for allowing said frame to move from a first rest position at a first distance from a ground surface over which said frame is positioned when configured for use in tree extraction and a second, extraction position wherein said frame is positioned at a greater distance from said ground surface than when at said rest position;
first and second jaw members supported in a substantially static position relative to said frame and configured for, upon juxtaposition to each other, substantially encircling and mechanically grasping a substantially circular object;
jaw actuation means operably engaged with at least one of said jaw members for moving at least one of said jaw members from a first open position relative to the other said jaw member toward a second grabbing position relative to said other jaw member;
a leg member attached to said frame, said leg member including a hydraulic cylinder assembly, a hydraulic piston of which has attached to a distal end a ground engaging plate member, said leg member being oriented whereby, upon actuation of said hydraulic cylinder assembly when said frame is attached to a said host vehicle and positioned for operation in tree extraction, said ground engaging plate member approaches and presses against a ground surface, a throw length of said hydraulic piston being of sufficient length to force said frame from said rest position to said extraction position.
